(19) United States
(12) Patent Application Publication
(10) Pub. No.: US 2024/0428259 A1
(43) Pub. Date: Dec. 26, 2024

(54) METHOD AND SYSTEM FOR PROVIDING CUSTOMER-SPECIFIC INFORMATION

(71) Applicant: STATE FARM MUTUAL AUTOMOBILE INSURANCE COMPANY, Bloomington, IL (US)

(72) Inventors: Ross Wheeler, Scottsdale, AZ (US); Lauren Mitchell, Phoenix, AZ (US); Jose Ivan Gutierrez, Laveen, AZ (US); Anthony Welcome, Mesa, AZ (US); Steve Amancha, Tempe, AZ (US)

(21) Appl. No.: 18/506,422

(22) Filed: Nov. 10, 2023

Related U.S. Application Data
(60) Provisional application No. 63/539,913, filed on Sep. 22, 2023.
(60) Provisional application No. 63/522,535, filed on Jun. 22, 2023.

(51) Int. Cl. G06Q 30/015; G06F 40/40

(52) U.S. Cl. CPC G06Q 30/015; G06F 40/40

(57) ABSTRACT

Apparatuses, systems and methods are disclosed for providing customer-specific information. The method comprises: (1) receiving, by one or more processors from a user device, a first prompt associated with a customer; (2) creating, by the one or more processors, a vector associated with the first prompt; (3) comparing, by the one or more processors, the vector associated with the first prompt with vectors associated with a plurality of documents associated with the customer to identify one or more candidate documents from the plurality of documents; (4) creating, by the one or more processors, a second prompt based upon the first prompt and the one or more candidate documents; (5) inputting, by the one or more processors, the second prompt into a chatbot to obtain a response to the second prompt; and/or (6) presenting, by the one or more processors, the response via the user device.

### CROSS-REFERENCE TO RELATED APPLICATIONS

This application claims priority to and the benefit of the filing date of (1) provisional U.S. Patent Application No. 63/522,535 entitled “METHOD AND SYSTEM FOR PROVIDING CUSTOMER-SPECIFIC INFORMATION,” filed on Jun. 22, 2023, and (2) provisional U.S. Patent Application No. 63/539,913 entitled “METHOD AND SYSTEM FOR PROVIDING CUSTOMER-SPECIFIC INFORMATION,” filed on Sep. 22, 2023. The entire disclosure of each of the above-identified applications is hereby expressly incorporated herein by reference.

### FIELD OF THE INVENTION

The present disclosure generally relates to systems and methods for providing customer-specific information, and more particularly, using chatbots or other bots for providing customer-specific information.

### BACKGROUND

Chatbots utilizing generative pre-trained transformer (GPT) models (such as ChatGPT®) are powerful tools that may generate realistic and engaging responses to user inputs. A GPT-based chatbot, however, may not always provide factual or accurate information in its responses, especially when the conversation involves specific or specialized knowledge. The chatbot may make up facts, misinterpret information, or confuse different domains or entities, i.e., have the so-called chatbot “hallucinations.” Accordingly, conventional methods or systems of utilizing chatbots to provide information may fail to provide accurate information associated with a specific customer as the chatbots may confuse information of the specific customer with other customers and/or make other mistakes.

The conventional methods or systems of utilizing chatbots to generate responses may include additional ineffectiveness, inefficiencies, encumbrances, and/or other drawbacks.

### SUMMARY

The present embodiments may relate to, inter alia, systems and methods for providing customer-specific information using a chatbot, a voice bot, or other bot.

In one aspect, a computer-implemented method for providing customer-specific information may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in one instance, the computer-implemented method may include: (1) receiving, by one or more processors from a user device, a first prompt associated with a customer; (2) creating, by the one or more processors, a vector associated with the first prompt; (3) comparing, by the one or more processors, the vector associated with the first prompt with vectors associated with a plurality of documents associated with the customer to identify one or more candidate documents from the plurality of documents; (4) creating, by the one or more processors, a second prompt based upon the first prompt and the one or more candidate documents; (5) inputting, by the one or more processors, the second prompt into a chatbot to obtain a response to the second prompt; and/or (6) presenting, by the one or more processors, the response via the user device. The method may include additional, less, or alternate functionality or actions, including those discussed elsewhere herein.

In another aspect, a computing system for providing customer-specific information may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, ChatGPT or ChatGPT-based bots, and/or other electronic or electrical components, which may be in wired or wireless communication with one another. For example, in one instance, the computing system may include one or more processors, and a non-transitory memory storing one or more instructions, the instructions, when executed by the one or more processors, cause the one or more processors to: (1) receive, from a user device, a first prompt associated with a customer; (2) create one or more vectors associated with the first prompt; (3) compare the one or more vectors associated with the first prompt with vectors associated with a plurality of documents associated with the customer to identify one or more candidate documents from the plurality of documents; (4) create a second prompt based upon the first prompt and the one or more candidate documents; (5) input the second prompt into a chatbot to obtain a response to the second prompt; and/or (6) present the response to a user via the user device. Additional, alternate and/or fewer actions, steps, features and/or functionality may be included in an aspect and/or embodiments, including those described elsewhere herein.

In another aspect, a computer readable storage medium storing non-transitory computer readable instructions that, when executed by one or more processors, cause the one or more processors to: (1) receive, from a user device, a first prompt associated with a customer; (2) create one or more vectors associated with the first prompt; (3) compare the one or more vectors associated with the first prompt with vectors associated with a plurality of documents associated with the customer to identify one or more candidate documents from the plurality of documents; (4) create a second prompt based upon the first prompt and the one or more candidate documents; (5) input the second prompt into a chatbot to obtain a response to the second prompt; and/or (6) present the response to a user via the user device. The instructions may direct additional, less, or alternate functionality, including that discussed elsewhere herein.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer environment in which methods and systems for providing customer-specific information are implemented according to one embodiment.

FIG. 2 depicts a combined block and logic diagram in which exemplary computer-implemented methods and systems for training an ML chatbot or an AI model are implemented according to one embodiment.

FIG. 3 depicts an exemplary display of an application implementing a method for providing customer-specific information according to one embodiment.

FIGS. 4A-4C depict signal diagrams of an exemplary computer-implemented method for providing customer-specific information according to one embodiment.

FIG. 5 depicts a flow diagram of an exemplary computer-implemented method for providing customer-specific information according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The methods and systems disclosed herein generally relate to, inter alia, methods and systems for providing customer-specific information using a chatbot and/or other bot.

In one aspect, a computer system may identify documents associated with a specific customer based upon a first prompt associated with the specific customer. The system may then generate a second prompt that indicates the identified documents. As such, the chatbot that receives the second prompt may generate a response based upon the identified documents, rather than the information acquired during a training process, most (if not all) of which may not be related to the specific customer. In this way, the present disclosure provides an improved system and method for utilizing a chatbot to generate information by increasing the accuracy of information generated by a chatbot when the chatbot is asked for information related to specific customers.

Furthermore, the capability of a chatbot to “pay attention” to prompts is limited to a certain number of words (e.g., 25,000 words for ChatGPT-4) due to the complexity of the model it implements (e.g., a GPT model) and the limited computation resources allocated to a user. As the word number of a prompt increases, the computation resources required to handle the prompt increase significantly. In certain embodiments, the system disclosed herein may identify and incorporate only the most relevant portions of the documents into the second prompt. In this way, the system would allow the chatbot to generate information more efficiently by dedicated fewer of the contextual resources available to the chatbot to less relevant data. Moreover, with less information to pay attention to, the chatbot may generate information more accurately.

As used herein, the term “user” may refer to a person that uses a system disclosed herein or an application implementing a method disclosed herein, such as a policyholder, or a representative or an agent of an enterprise utilizing a system or method disclosed herein.

As used herein, the term “customer” may refer to a person or an entity that interfaces with products and/or services from an enterprise utilizing a system or method disclosed herein such that the enterprise maintains records associated with the customer in a database. In some embodiments, the “user” and the “customer” may be the same person or entity.

### I. EXEMPLARY COMPUTING ENVIRONMENT

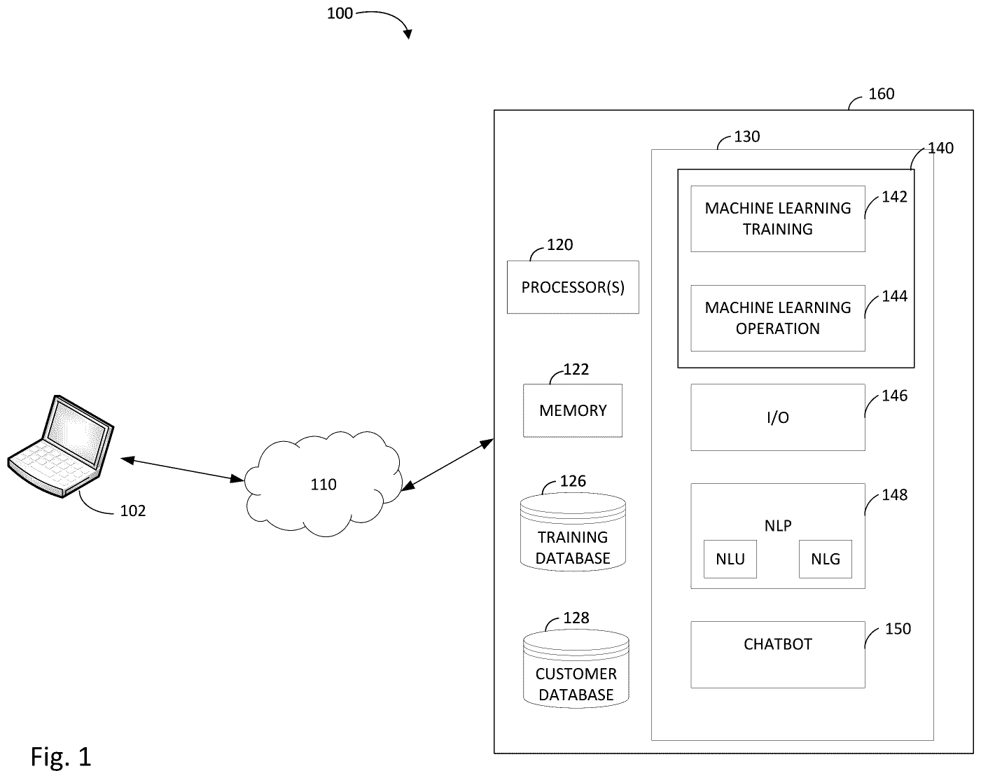

FIG. 1 depicts a block diagram of an exemplary computing environment 100 in which providing customer-specific information may be performed, in accordance with various aspects discussed herein.

In the exemplary aspect of FIG. 1, the computing environment 100 includes a user device 102. In various aspects, the user device 102 comprises one or more computing devices, which may comprise multiple, redundant, or replicated client computing devices accessed by one or more users. The computing environment 100 may further include an electronic network 110 communicatively coupling other aspects of the computing environment 100.

The user device 102 may be any suitable device, including one or more computers, mobile devices, wearables, smart watches, smart contact lenses, smart glasses, augmented reality glasses, virtual reality headsets, mixed or extended reality glasses or headsets, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

In one aspect, one or more servers 160 may perform the functionalities as part of a cloud network or may otherwise communicate with other hardware or software components within one or more cloud computing environments to send, retrieve, or otherwise analyze data or information described herein. For example, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., a business) may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business).

Alternatively, or in addition, aspects of the public cloud may be hosted on-premise at a location owned/controlled by an enterprise. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 3G, 4G, 5G, etc.). Generally, the network 110 enables bidirectional communication between the user device 102 and the servers 160. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (WIFI), Bluetooth, and/or the like.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122, a training database 126, and/or a customer database 128.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang. Python, C, C++, C#, Objective-C, Java, Scala, ActionScript, JavaScript, HTML, CSS, XML, etc.).

The training database 126 may be a relational database, such as Oracle, DB2, MySQL, a NoSQL based database, such as MongoDB, or another suitable database. The training database 126 may store data and be used to train and/or operate one or more ML models, chatbots, and/or voice bots.

The customer database 128 may be a relational database, such as Oracle, DB2, MySQL, a NoSQL based database, such as MongoDB, or another suitable database. The customer database 128 may store customer data. For example, the customer database 128 may store insurance claim forms, medical records, bills, and/or police reports associated with the customer, and any feature vectors associated therewith. Accordingly, the collection of feature vectors included in the customer database 128 may be referred to herein as a “vector database.” In some other embodiments, the vector database is a separate database than the customer database 128. Because the customer data may be difficult to reconstruct from the feature vectors, maintaining a separate vector database helps maintain the privacy of customer data while still enabling the ML models, chatbots, and/or voice bots to act upon the pertinent characteristics thereof.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, support vector machines and generative pre-trained transformers. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 160. For example, libraries may include the TensorFlow based library, the PyTorch library, a HuggingFace library, and/or the scikit-learn Python library.

In one embodiment, the ML module 140 may employ supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprise a set of computer-executable instructions implementing ML loading, configuration, initialization and/or operation functionality. The MLOM 144 may include instructions for storing trained models (e.g., in the training database 126). As discussed, once trained, the one or more trained ML models may be operated in inference mode, whereupon when provided with a de novo input that the model has not previously been provided, the model may output one or more predictions, classifications, etc., as described herein.

In some embodiments, the ML module 140 includes a ML model for transcribing text from audios. The ML model include a plurality of parameters. The ML model may be trained with audios and corresponding texts. When training the ML model, the plurality of parameters may be updated iteratively. Updating the parameters may be based upon a difference between a transcription result and the text associated with the audio. For example, a particular audio associated with text “good” may be used to train the ML model. If the ML model transcribe the audio as “good.” in this particular training iteration, the parameters of the ML model do not need to be updated. If the ML model transcribes the audio as “god,” the parameters may need some updates. If, for example, the ML transcribes the audio as “but,” the parameters may need substantial updates. When the transcription results meet a predetermined accuracy requirement, the ML model may be ready for use.

In some embodiments, the ML module 140 includes a ML model for extracting texts from images. The ML model may be trained with images or visual documents and corresponding texts in a similar manner described herein above with respect to training a ML model for transcribing texts from audios.

In some embodiments, the ML module 140 includes a ML model for encoding a semantic cluster into a vector. The ML model may be trained with a large corpus of text. The ML model may include a plurality of parameters. When training the ML model, the ML model may determine set of values for the parameters based upon the word association in a first document. For example, the parameters that reflect an association between the words “cat” and “dog” may be determined based upon a first document in which the words “cat” and “dog” appear together frequently. When training the ML model with the document with a second document where the words “cat” and “dog” appear together less frequently than the first document, the parameters may be updated to reflect a change in the association between the words “cat” and “dog.” When the updates in the training process only produce minor changes in the parameter values, the ML model may be ready for use.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the computer network 110 and/or the user device 102 (for rendering or visualizing) described herein. In one aspect, the servers 160 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, servers 160 or may be indirectly accessible via or attached to the user device 102. According to an aspect, an administrator or operator may access the servers 160 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module 148 may include NLU processing to understand the intended meaning of utterances, among other things. The NLP module 148 may include NLG which may provide text summarization, machine translation, and/or dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, and recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT bot, an InstructGPT bot, a Codex bot, or a Google Bard bot. The voice bot or chatbot 150 may employ supervised or unsupervised ML techniques, which may be followed by, and/or used in conjunction with, reinforced or reinforcement learning techniques. The voice bot or chatbot 150 may employ the techniques utilized for ChatGPT, ChatGPT bot, InstructGPT bot, Codex bot, or Google Bard bot.

Noted above, in some embodiments, a chatbot 150 or other computing device may be configured to implement ML, such that server 160 “learns” to analyze, organize, and/or process data without being explicitly programmed. ML may be implemented through ML methods and algorithms. In one exemplary embodiment, the ML module 140 may be configured to implement ML methods and algorithms.

In operation, the MLTM 142 may access training database 126 or any other data source for training data suitable to generate one or more ML models, e.g., as part of an “ML chatbot.” The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained ML model may be loaded into MLOM 144 at runtime, may process the user inputs and/or utterances, may generate as an output conversational dialog.

While various embodiments, examples, and/or aspects disclosed herein may include training and generating one or more chatbots 150 for the server 160 to load at runtime, it is also contemplated that one or more appropriately trained ML chatbots 150 may already exist (e.g., in training database 126) such that the server 160 may load an existing trained chatbot 150 at runtime. It is further contemplated that the server 160 may retrain, update and/or otherwise alter an existing chatbot 150 before loading the model at runtime.

Although the computing environment 100 is shown to include one user device 102, one server 160, and one network 110, it should be understood that different numbers of user devices 102, networks 110, and/or servers 160 may be utilized. In one example, the computing environment 100 may include a plurality of servers 160 and hundreds or thousands of user devices 102, all of which may be interconnected via the network 110. Furthermore, the database storage or processing performed by the one or more servers 160 may be distributed among a plurality of servers 160 in an arrangement known as “cloud computing.” This configuration may provide various advantages, such as enabling near real-time uploads and downloads of information as well as periodic uploads and downloads of information.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, server 160, and network 110, etc., various aspects include the computing environment 100 implementing any suitable number of any of the components shown in FIG. 1 and/or omitting any suitable ones of the components shown in FIG. 1. For instance, information described as being stored at server training database 126 may be stored at memory 122, and thus training database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 160 and user device 102 may be connected via a direct communication link (not shown in FIG. 1) instead of, or in addition to, via network 110.

### II. EXEMPLARY TRAINING OF THE ML CHATBOT MODEL

An enterprise may be able to use programmable chatbots, such as the chatbot 150 and/or an ML chatbot (e.g., ChatGPT), to provide tailored, conversational-like customer service relevant to a line of business. The chatbot may be capable of understanding customer requests, providing relevant information, escalating issues, any of which may assist and/or replace the need for customer service assets of an enterprise. Additionally, the chatbot may generate data from customer interactions which the enterprise may use to personalize future support and/or improve the chatbot's functionality, e.g., when retraining and/or fine-tuning the chatbot.

In certain embodiments, the machine learning chatbot may be configured to utilize artificial intelligence and/or machine learning techniques. For instance, the machine learning chatbot or voice bot may be a ChatGPT chatbot. The machine learning chatbot may employ supervised or unsupervised machine learning techniques, which may be followed by, and/or used in conjunction with, reinforced or reinforcement learning techniques. The machine learning chatbot may employ the techniques utilized for ChatGPT. The machine learning chatbot may be configured to generate verbal, audible, visual, graphic, text, or textual output for either human or other bot/machine consumption or dialogue.

The ML chatbot may provide advance features as compared to a non-ML chatbot. For example, the ML chatbot may include and/or derive functionality from a large language model (LLM). The ML chatbot may be trained on a server, such as the server 160, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user prompts and/or utterances, which may require the ML chatbot to keep track of an entire conversation history as well as the current state of the conversation. The ML chatbot may rely on various techniques to engage in conversations with users, which may include the use of short-term and long-term memory. Short-term memory may temporarily store information that may be required for immediate use and may keep track of the current state of the conversation and/or to understand the user's latest input in order to generate an appropriate response. Long-term memory may include persistent storage of information which may be accessed over an extended period of time. The long-term memory may be used by the ML chatbot to store information about the user (e.g., preferences, chat history, etc.) and may be useful for improving an overall user experience by enabling the ML chatbot to personalize and/or provide more informed responses.

The system and methods to generate and/or train an ML chatbot model (e.g., via the ML module 140 of the server 160) which may be used the an ML chatbot, may consists of three steps: (1) a supervised fine-tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

In some embodiments, the language model may be pre-trained by a set of vectors associated with a set of training data. The set of training data may include documents. Creating the set of vectors may include (1) extracting text from documents, (2) splitting the text into semantic clusters, and (3) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

In some embodiments, the server 160 or an external computing device may encode the vectors using a trained machine learning model (e.g., via the ML module 140). The trained machine learning model may include a plurality of parameters. When training the machine learning model, the plurality of parameters may be updated iteratively. In other embodiments, the server 160 may encode the vectors using existing encoding tables and/or libraries.

### A. Supervised Fine-Tuning ML Model

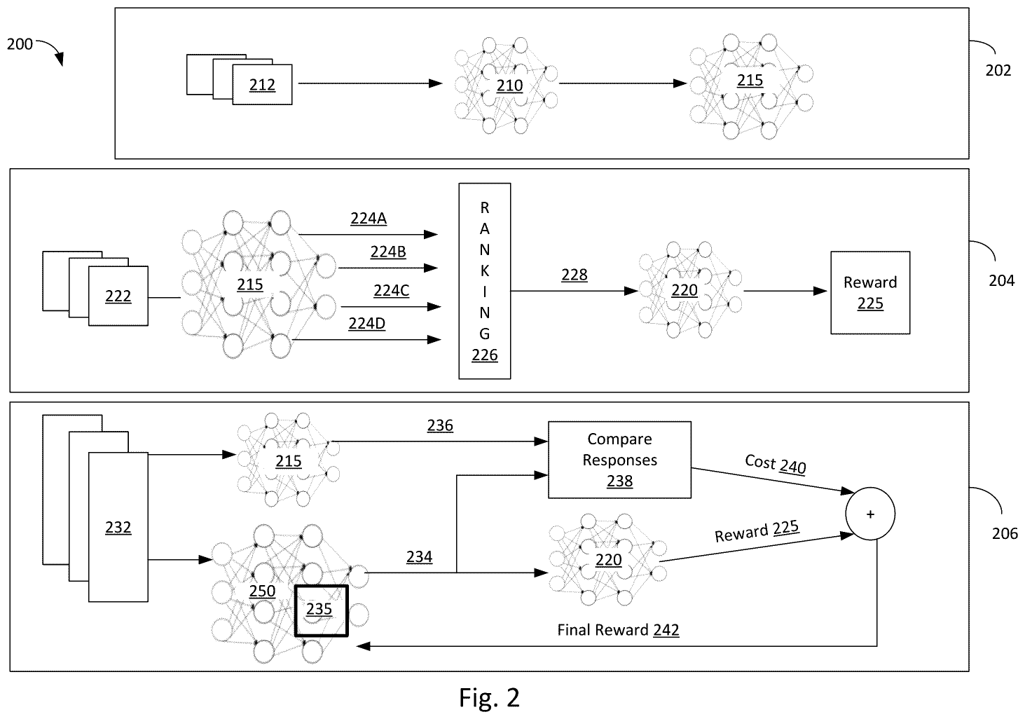

FIG. 2 depicts a combined block and logic diagram 200 for training an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more servers 202, 204, 206, such as the server 160 or an external computing device.

In one aspect, the server 202 may fine-tune a pretrained language model 210. The pretrained language model 210 may be obtained by the server 202 and be stored in a memory, such as memory 122. The pretrained language model 210 may be loaded into an ML training module, such as the MLTM 142, by the server 202 for retraining/fine-tuning. A supervised training dataset 212 may be used to fine-tune the pretrained language model 210 wherein each data input prompt to the pretrained language model 210 may have a known output response for the pretrained language model 210 to learn from. The supervised training dataset 212 may be stored in a memory of the server 202, e.g., the memory 122 or the training database 126. In one aspect, the data labelers may create the supervised training dataset 212 prompts and appropriate responses. The pretrained language model 210 may be fine-tuned using the supervised training dataset 212 resulting in the SFT ML model 215 which may provide appropriate responses to user prompts once trained. The trained SFT ML model 215 may be stored in a memory of the server 202, e.g., memory 122.

In some embodiments, the server 202 may fine-tune the pretrained language model 210 using a set of vectors associated with a set of training data. In some instances, the set of training data may include prompts associated with questions and documents, and responses associated with the prompts. Creating the set of vectors may include (1) splitting the text of the prompts, associated questions and/or associated documents into semantic clusters, and (2) encoding the semantic clusters as the set of vectors. The semantic clusters may be one or more words, a portion of a word, or a character. A distance between the vectors (e.g., a cosine distance, a Euclidean distance) may depend on a relevance between the semantic clusters corresponding to the vectors.

### B. Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on training database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B. 224C. 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 as input. The reward model 220 may provide as an output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 225 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate a response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### C. RLHF to Train the ML Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may advance from the SFT model 215 to the ML chatbot model 250. The policy 235 may represent a strategy that the ML chatbot model 250 learns to maximize the reward 225. As discussed herein, based upon prompt-response pairs, a human labeler may continuously provide feedback to assist in determining how well the ML chatbot's 250 responses match expected responses to determine the rewards 225. The rewards 225 may feed back into the ML chatbot model 250 to evolve the policy 235. Thus, the policy 235 may adjust the parameters of the ML chatbot model 250 based upon the rewards 225 it receives for generating good responses. The policy 235 may update as the ML chatbot model 250 provides responses 234 to additional prompts 232.

In one aspect, the response 234 of the ML chatbot model 250 using the policy 235 based upon the reward 225 may be compared using a cost function 238 to the SFT ML model 215 (which may not use a policy) response 236 of the same prompt 232. The cost function 238 may be trained in a similar manner and/or contemporaneous with the reward model 220. The server 206 may compute a cost 240 based upon the cost function 238 of the responses 234, 236. The cost 240 may reduce the distance between the responses 234, 236, i.e., a statistical distance measuring how one probability distribution is different from a second, in one aspect the response 234 of the ML chatbot model 250 versus the response 236 of the SFT model 215. Using the cost 240 to reduce the distance between the responses 234, 236 may avoid a server over-optimizing the reward model 220 and deviating too drastically from the human-intended/preferred response. Without the cost 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward 225. The ML chatbot model 250 response 234 may be compared via the cost function 238 to the SFT ML model 215 response 236 by the server 206 to compute the cost 240. The server 206 may generate a final reward 242 which may include the scalar reward 225 offset and/or restricted by the cost 240. The final reward 242 may be provided by the server 206 to the ML chatbot model 250 and may update the policy 235, which in turn may improve the functionality of the ML chatbot model 250.

To optimize the ML chatbot 250 over time, RLHF via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### III. EXEMPLARY GRAPHICAL USER INTERFACE (GUI)

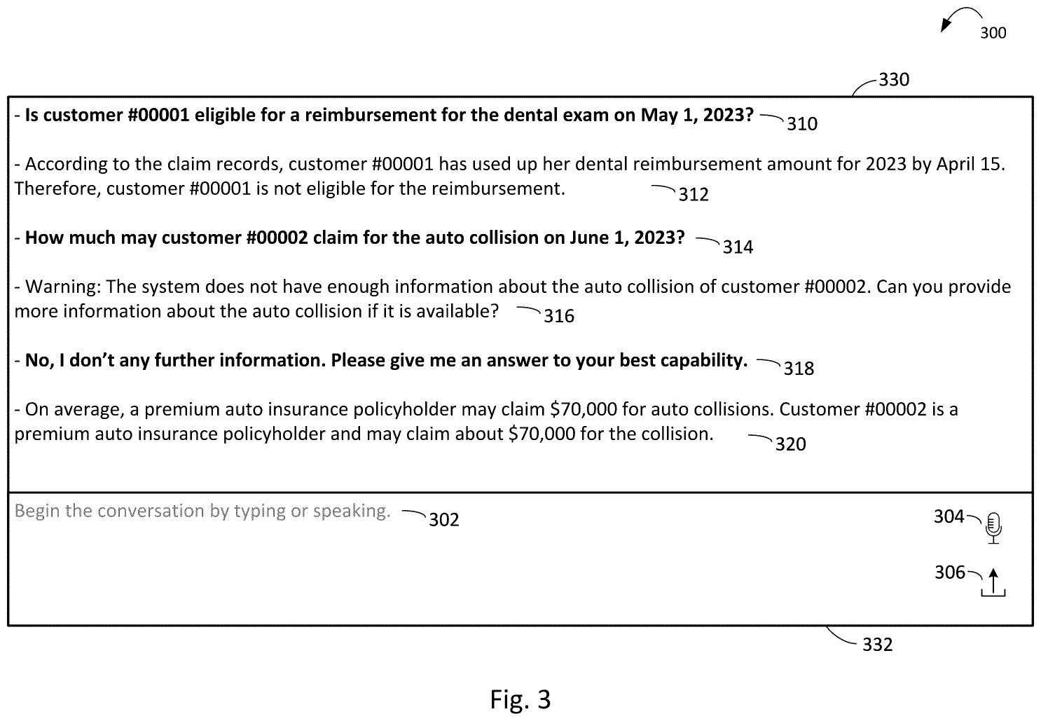

FIG. 3 depicts an exemplary GUI 300 of an application implementing a method disclosed herein for providing customer-specific information, according to one embodiment. The GUI 300 may include a chat interface 330 via which the GUI presents the user's inputs and responses generated to the user's inputs.

Further, the GUI 300 may include an input interface 332. The GUI 300 may display a thread 302 in the input interface to prompt the user to input information into the GUI 300. The user may input information via text (e.g., by typing) and/or audio (e.g., by speaking), and/or uploading files (e.g., images, videos, etc.). In scenarios where the user responds by typing, the user may type in the input interface 332. In scenarios where the user responds by speaking, the user may interact with a selectable element 304 to begin speaking. The user device 102 may transcribe the audio data and enter the transcribed audio into the chat interface 330.

In some embodiments, the GUI 300 may include a selectable element 306 to allow a user to upload files. For example, the user may wish to upload files associated with a customer when the information associated with the customer is not sufficient to answer the user's question. In such scenarios, the user may interact with selectable element 306 to begin uploading files.

Upon the user making an input, the GUI 300 may present the user's input in the chat interface 330, such as the inputs 310, 314, and 318. The user's input may be a question associated with a customer, such as the inputs 310 and 314. The application may generate a response to the question and present the response in the chat interface 330, such as the responses 312, 316, and 320.

In some embodiments, the application may determine that existing information and/or documents are not sufficient to answer the question. In such scenarios, the application may present a warning to the user, and prompt to the user to provide more information and/or documents, such as the response 316. Alternatively, the application may still present a response to the question with or without a warning, such as the response 320.

### IV. EXEMPLARY COMPUTER-IMPLEMENTED METHODS

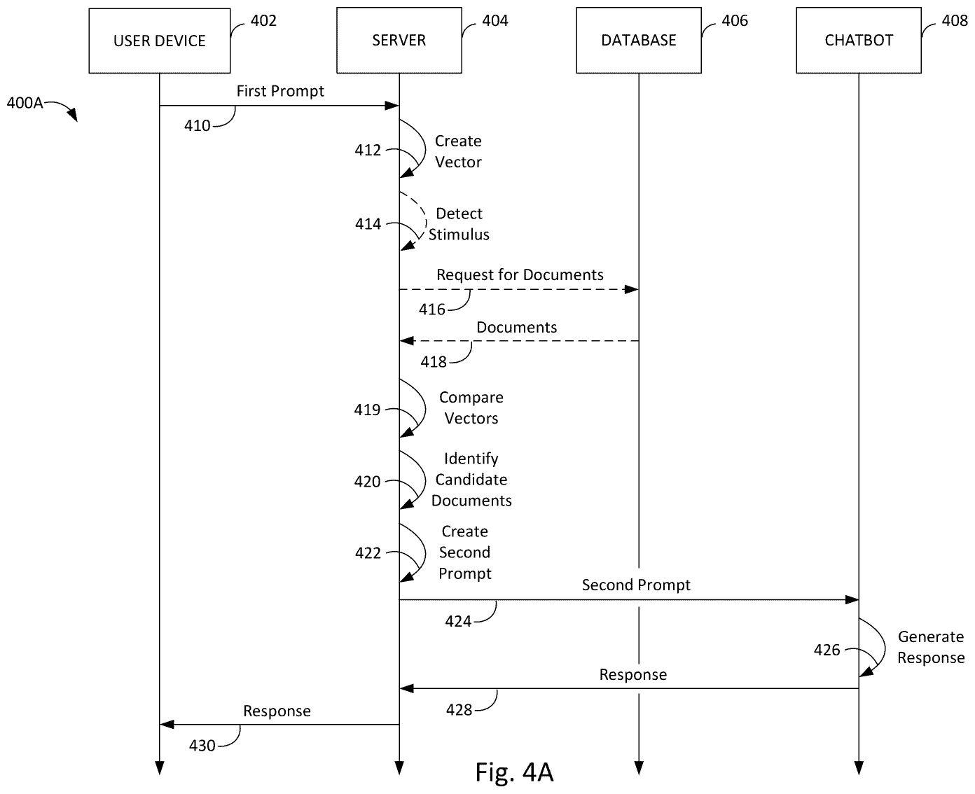

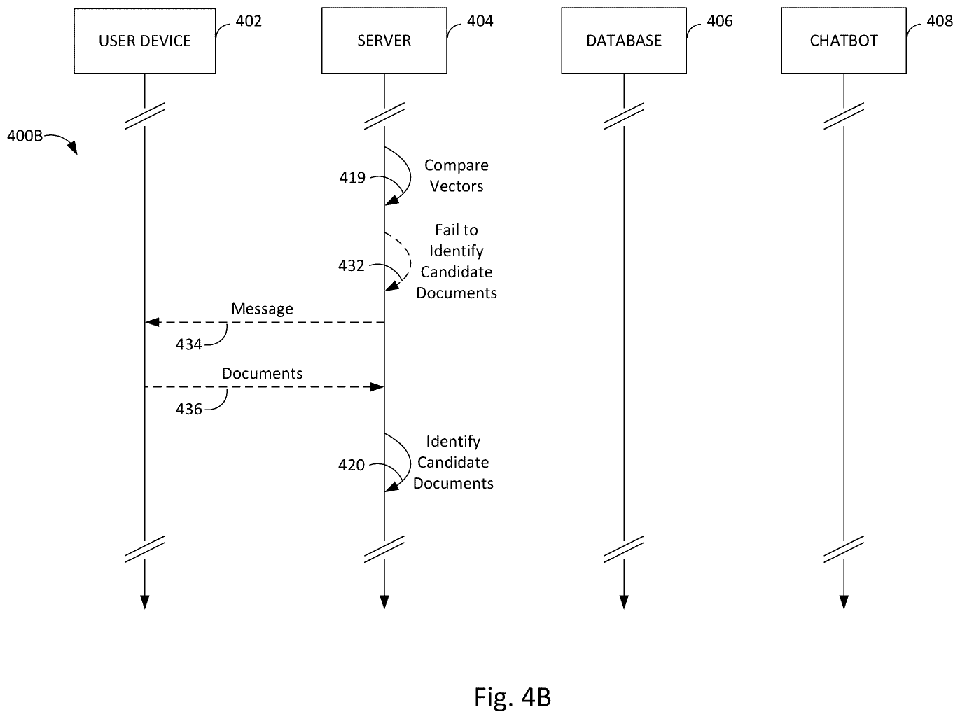

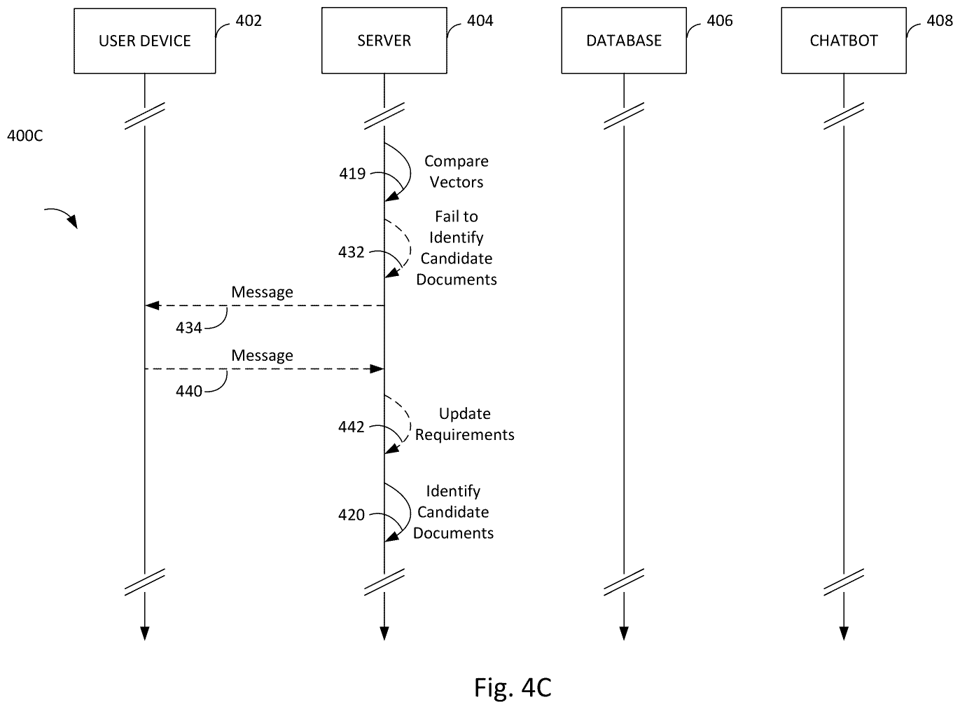

FIGS. 4A-4C depict signal diagrams 400A-400C of an exemplary computer-implemented method for providing customer-specific information according to one embodiment. The steps described with reference to the signal diagrams 400A-400C may be implemented, for example, in the computing environment 100 or other computing environment alternatively envisioned.

The signal diagram 400A may begin when a user inputs a first prompt to a user device 402 (such as the user device 102 of FIG. 1). The first prompt may be a question associated with a customer (such as the questions 310 and 314). For example, the user may be an enterprise representative of an insurance company, and the customer may be a policyholder of the insurance company. The question may be an inquiry with respect to an accident history of the customer, a description of an injury of the customer, a causation of an injury of the customer, a health condition of the customer prior to an injury, a general medical history of the customer, a medical history of the customer associated with an injury, a description of a property damage, a causation of a property damage, a repair and/or replacement history associated with a property damage, a description of a property loss, a causation of a property loss, a replacement history associated with a property loss, and/or a monetary amount requested by the customer.

The user device 402 may transmit (410) the first prompt to the server 404 (such as the server 160 of FIG. 1). In certain embodiments, the first prompt and/or question may be in verbal, audible, visual, textual, graphical, document, and/or other form or format.

When the first prompt is verbal or audible, the server 404 may transcribe the prompt into texts and process the texts accordingly. In some embodiments, transcribing the first prompt may include (1) pre-processing the first prompt (e.g., removing white noise, removing sounds outside of a frequency band of human voice, etc.), and (2) using a trained machine learning model (such as a ML model in the ML module 140) to generate texts based on the first prompt.

When the first prompt is visual or graphical, the server 404 may extract texts from the visual or graphical prompt. In some embodiments, the texts may be extracted using OCR techniques. In other embodiments, the texts may be extracted using a trained machine learning model (such as a ML model in the ML module 140).

Upon receiving the first prompt from the user device 402, the server 404 may create (412) a vector associated with the first prompt. Creating the vector associated with the first prompt may include: (1) splitting texts of the first prompt into semantic clusters, and (2) determining a feature vector of the first prompt based upon the semantic clusters.

A semantic cluster may be one or more words, a portion of a word, and/or a character. When the semantic cluster is a word, the server 404 may split sentences by spaces and punctuation. When the semantic cluster is phrase comprising more than one words, the server 404 may first split the sentence into words, and then cluster related words together. For example, the server 404 may compare the words with a table of commonly used phrases and determine a plurality of consecutive words to be a semantic cluster if the plurality of consecutive words forms a phrase in the table. When the semantic cluster is a portion of word, the server 404 may (i) first split the sentence into words, and then further split each word if needed, or (ii) split the sentence into words and word portions (when appropriate) directly. For example, the server 404 may compare the words with a table of predetermined word portions and determine a particular portion of a word to be a semantic cluster if the particular portion is in the table.

In some embodiments, the server 404 may determine the feature vector by encoding the semantic clusters into the feature vector directly. Various techniques may be used to perform this step, such as Bag of Words, support vector machines (SVM), transformers (such as Bidirectional Encoder Representations from Transformers (BERT)), etc.

In other embodiments, the server 404 may determine the feature vector by (1) encoding the semantic clusters as a set of vectors, and (2) determining a feature vector based upon the set of vectors associated with the semantic clusters.

Various techniques may be used to encode a semantic cluster into a vector, such as word2vec, which uses a machine model trained with a large corpus of text to learn word association. In some instances, a distance between the vectors reflects a semantic similarity between the corresponding semantic clusters, i.e., a smaller distance between two vectors corresponds to a greater similarity in semantic meanings between two corresponding semantic clusters. The distance between vectors may be a cosine distance, a Euclidean distance, or any other appropriate distance for vectors.

Various techniques may be used to determine a feature vector for a set of vectors. For example, a feature vector may be a mean vector or a weighted sum of the set of vectors. In another example, the server 404 may combine the set of vectors into a matrix, calculate an eigenvector of the resulting matrix, and use the eigenvector as the feature vector. In yet another example, the server 404 may use a trained machine learning model (such as Recurrent Neural Networks (RNN), Bidirectional Encoder Representations from Transformer (BERT), etc.) to determine a feature vector for the set of semantic clusters.

In some optional embodiments, the user may cause (e.g., via the user device 402) the server 404 to retrieve (416 and 418) a plurality of the documents associated with the customer from a database 406 (such as the customer database 128 or a database external to the server 160). The database 406 may be a database dedicated exclusively for the customer, or a portion of a customer database (e.g., a record of a database) dedicated exclusively for the customer. The plurality of documents may include insurance claim forms, medical records, bills, and/or police reports associated with the customer.

In other optional embodiments, the server 404, upon detecting (414) a stimulus associated with an insurance claim process, may retrieve (416 and 418) the plurality of documents associated with customer from the database 406 automatically. The stimulus may be the customer originating a conversation with an enterprise representative associated with the insurance claim process, the customer updating an insurance claim associated with the insurance claim process, an update to documents associated with the insurance claim process, and/or detecting new documents associated with the insurance claim process. While the aforementioned stimuli relate to stimuli for retrieving documents when the instant techniques are applied to insurance claim processes, in other embodiments where the instant techniques are applied to other processes, other appropriate stimuli may be used.

In some embodiments, the vectors of the plurality of documents may be created in a similar manner for creating the vector for the first prompt as described herein above with respect to block 412. The vectors of the plurality of documents may be created by the server 404 or by an external computing device. In either scenario, the vectors may be stored in a vector database and the server 404 may retrieve the vectors from the vector database when needed.

In some embodiments, a vector associated with a particular document may be created based upon the entire content of the particular document. In some instances, various portions of the particular document may be weighted differently in creating the feature vector. For example, the texts in a title may be assigned with a greater weight than the texts in the main body of the particular document.

In other embodiments, the feature vector may be created based upon a portion or a chunk of the particular document. For example, the feature vector may be created based upon one or more titles in the particular document. In another example, the feature vector may be created based upon a major chunk of the particular document, such the longest section of the particular document.

In some embodiments, to ingest a particular document, the server 404 may (1) separate the particular document into a set of chunks, (2) create a respective vector corresponding to the chunks in the set of chunks, and (3) store vectors corresponding to the set of chunks in a vector database (e.g., a relational data table). The server 404 may maintain a relationship between the set of chunks and the particular document in a relational data table. Chunking the document may be based upon punctuation, such as a chapter, a section, or a paragraph being a portion. Alternatively, a portion may be based upon semantic meanings. For example, if a semantic distance between two paragraphs is below a predetermined threshold, the two paragraphs may be determined as one portion. The semantic distance may be determined in a similar manner as determining semantic distance between a vector associated with first prompt and a vector associated a document as described herein above. After chunking the particular document, a feature vector may be created for each chunk in a similar manner of creating a feature vector for a document as described herein above.

Upon creating the vector associated with the first prompt and/or receiving documents associated with the customer, the server 404 may compare (419) the vector associated with the first prompt and vectors associated with a plurality of documents associated with the customer. The comparison between the vectors of the first prompt and the documents may produce similarity values between the first prompt and the plurality of documents based upon distances (e.g., a cosine distance, a Euclidean distance, etc.) between the vectors associated with the first prompt and the plurality of documents. The similarity values may further by classified into qualitative levels, e.g., high similarity, medium similarity, and low similarity.

Based upon the similarity values or levels produced by the comparison, the server 404 may identify (420) one or more candidate documents from the plurality of documents.

In some embodiments, the candidate documents may be documents that have at least a particular similarity (or semantic relevance) with the first prompt. For example, for a document to be identified as a candidate document, a distance between vector associated with the first prompt and the vector associated with the document must be no greater than a distance threshold.

In the case where more than one vectors are created for a particular document (i.e., creating a feature vector for each chunk of the particular document), the comparison may be performed between the first prompt and the chunks of a particular document, instead of the particular document itself. The server 404 may then identify (420) one or more document chunks based upon the comparison.

Turning to FIG. 4B, in some embodiments, after the comparison (419) between the vectors of the first prompt and the candidate documents (or document chunks), the server 404 may fail (432) to identify a sufficient number of candidate documents that meet the similarity requirement. For example, the distance between vector of the first prompt and the vectors of the candidate documents is greater than a preferred distance threshold. In such scenarios, the server 404 may transmit (434) a message to the user device 402. The message may request the user device 402 to warn the user of a potential inaccuracy of the response and/or solicit relevant documents from the user. The user device 402 may present a message generated for such purposes (such as the response 316) to the user.

If the user uploads documents in response to the solicitation, the user device 402 may transmit (436) the uploaded documents to the server 404. In some instances, the server 404 may determine the uploaded documents as relevant documents and indicate the documents in a second prompt in a manner as will be disclosed herein below. In other instances, the server 404 may process the uploaded documents in a similar manner of processing existing documents in the database 406 as described herein.

Turning to FIG. 4C, in some embodiments, after the server 404 transmits (434) a message soliciting more documents, the user may fail to upload documents in response to the solicitation. In such scenarios, the user device 402 may transmit (440) a message to the server 404 indicating the user's failure to upload relevant documents. In response to the message, or in response to the insufficiency of candidate documents, in some embodiment, the server 404 may update the similarity requirements, such as lower the similarity threshold. The server 404 may then identify one or more candidate documents based upon the lowered similarity requirement. In other embodiments, the server 404 may identify as candidate documents the documents that have highest similarities with respect to the first prompt.

Turning back to FIG. 4A, upon identifying (420) the one or more candidate documents, the server 404 may create (422) a second prompt based upon the first prompt and the one or more candidate documents.

In some embodiments, the server 404 may create the second prompt by combining a reference to the one or more candidate documents with the first prompt. The reference may be an identifier of the document (e.g., the title, the author, and/or the publication date of the document), a Uniform Resource Locator (URL) linked to the document, and/or an address of the document in the database 406.

In other embodiments, the server 404 may create the second prompt by combining a content of the one or more candidate documents (e.g., the texts, the images, the audios and/or the videos of the document) with the first prompt.

In the embodiments where more than one vectors are created for a particular document, the second prompt may refer to the chunks associated with more than one vectors or incorporate the content of the chunks. The chunks incorporated in the second prompt may be chunks that are most relevant to the first prompt based upon a semantic distance as described herein above.

Upon creating the second the second prompt, the server 404 may input (424) the second prompt into a chatbot 408 (such as the chatbot 150 or a chatbot external to the server 160). The chatbot 408 may generate (426) may generate a response to the second prompt and transmit (428) the response to the server 404. The chatbot 408 may be a machine learning (ML) chatbot, an artificial intelligence (AI) chatbot, a large language model (LLM), or any other chatbot compliant to be used in the system and method described herein. The chatbot 408 may be trained in the manner as described herein above with respect to FIG. 2.

Upon receiving the response from the chatbot 408, the server 404 may transmit (430) the response to the user device 402. The user device 402 may present the response to the user (such as the responses 312, 316, and 320). The user device 402 may present the response in texts or in audio, depending on the user's preference settings.

It should be understood that not all steps of the exemplary signal diagrams 400A-400C are required to be performed. It should be also understood that additional and/or alternative steps may be performed.

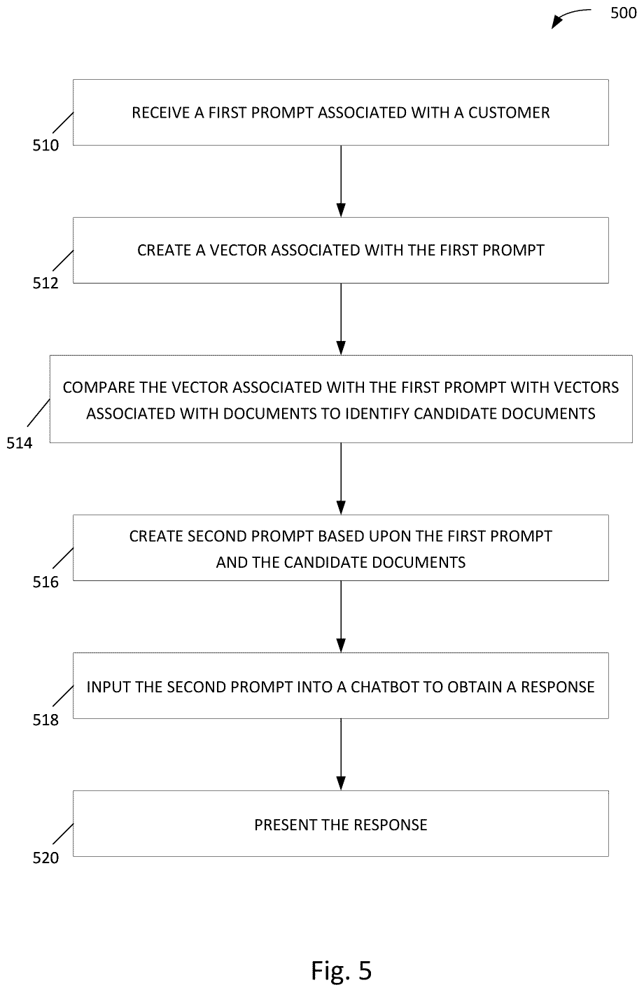

FIG. 5 depicts a flow diagram of an exemplary computer-implemented method 500 for customer-specific information, according to one embodiment. The method 500 may be performed by one or more processors of a server (such as the servers 160, 404).

The method 500 may begin at block 510 where the server receives a first prompt associated with a customer from a user device (such as the user devices 102, 402), as described herein above with respect to step 410 of FIG. 4A. The first prompt may include an inquiry regarding: an accident history of the customer, a description of an injury of the customer, a causation of an injury of the customer, a health condition of the customer prior to an injury, a general medical history of the customer, a medical history of the customer associated with an injury, a description of a property damage, a causation of a property damage, a repair and/or replacement history associated with a property damage, a description of a property loss, a causation of a property loss, a replacement history associated with a property loss, and/or a monetary amount requested by the customer.

At block 512, the server may create a vector associated with the first prompt, as described herein above with respect to step 412 of FIG. 4A. In some embodiments, to create the vector associated with the first prompt, the server may (a) split the first prompt into semantic clusters; (b) encode the semantic clusters as a set of vectors, wherein a similarity between the vectors associated with the semantic clusters depends on a relevance between the semantic clusters corresponding to the vectors; and/or (c) calculate a feature vector based upon the set of vectors associated with the semantic clusters, the feature vector being vector associated with the first prompt. In some embodiments, to encode the semantic clusters, the server may encode, via a machine learning (ML) model comprising a plurality of parameters, the set of vectors, wherein the plurality of parameters are iteratively updated during training of the ML model.

At block 514, the server may compare the vector associated with the first prompt with vectors associated with a plurality of documents associated with the customer (such as the customer documents stored in the customer database 128) to identify one or more candidate documents from the plurality of documents. In some embodiments, to compare the vector associated with the first prompt and the vectors associated with the plurality of documents to identify the one or more candidate documents, the server may determine similarity values between the vector associated with the first prompt and the vectors associated with the plurality of documents and select one or more candidate documents based upon the corresponding similarity values, as described herein above with respect to steps 419-420 of FIG. 4A. In some embodiments, the plurality of documents include insurance claim forms, medical records, bills, and/or police reports associated with the customer.

In some embodiment, to ingest a particular document into the vector database, the server may (a) separate the particular document into a set of chunks; (b) create a respective vector corresponding to the chunks in the set of chunks; and/or (c) vectors corresponding to the set of chunks in a vector database (such as the customer database 128 or a database external to the server 160). In some embodiments, the vectors corresponding to the set of chunks may be associated with the plurality of documents and maintained in the vector database. In some embodiments, the server may maintain a relationship between the set of chunks and the particular document in a relational data table.

In some embodiments, to compare the vector associated with the first prompt with the vectors associated with the particular document, the server may compare the vector associated with the first prompt with vectors associated with the respective vectors corresponding to the chunks in the set of chunks.

In some embodiments, prior to comparing the vector associated with the first prompt with the vectors associated with the plurality of documents, the server may detect a stimulus associated with an insurance claim process and retrieve the plurality of documents from a record of a customer database associated with the customer, as described herein above with respect to steps 414-418 of FIG. 4A. The stimulus may be the customer originating a conversation with an enterprise representative associated with the insurance claim process, the customer updating an insurance claim associated with the insurance claim process, an update to documents associated with the insurance claim process, and/or detecting new documents associated with the insurance claim process.

At block 516, the server may create a second prompt based upon the first prompt and the one or more candidate documents, as described herein above with respect to step 420 of FIG. 4A.

At block 518, the server may input the second prompt into a chatbot (such as the chatbot 408) to obtain a response to the second prompt, as described herein above with respect to steps 424-428 of FIG. 4A. In some embodiments, the chatbot may implement a trained model. Training the model may include (a) creating a first set of vectors associated with first training data; (b) training the model in a first stage using the first set of vectors; (c) creating a second set of vectors associated with second training data, wherein the second training data include prompts associated with questions and documents, and responses associated with the prompts; and/or (d) training the model in a second stage using the second set of vectors.

At block 520, the server may present the response to the user via the user device, as described herein above with respect to step 430 of FIG. 4A and as shown in FIG. 3.

In some embodiments, the server may (a) receive, from the user device, a third prompt associated with the customer; (b) create a vector associated with the third prompt; (c) determine similarity values between the vector associated with the third prompt and the vectors associated with the plurality of documents; (d) determine that none of the plurality of documents meets a similarity threshold; and/or (c) performing, by the one or more processors, at least one of the following: (i) identifying a second one or more candidate documents from the plurality of documents based upon the corresponding similarity values; and/or (ii) presenting a warning to the user via the user device, as described herein above with respect to steps 412-420 of FIG. 4A and steps 432-442 of FIG. 4C.

It should be understood that not all blocks of the exemplary flow diagram 500 are required to be performed. It should be also understood that additional and/or alternative steps may be performed.

### V. EXEMPLARY EMBODIMENTS

In one aspect, a computer-implemented method for providing customer-specific information is disclosed herein. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in some embodiments, the method may include: (1) receiving, by one or more processors from a user device, a first prompt associated with a customer; (2) creating, by the one or more processors, a vector associated with the first prompt; (3) comparing, by the one or more processors, the vector associated with the first prompt with vectors associated with a plurality of documents associated with the customer to identify one or more candidate documents from the plurality of documents; (4) creating, by the one or more processors, a second prompt based upon the first prompt and the one or more candidate documents; (5) inputting, by the one or more processors, the second prompt into a chatbot to obtain a response to the second prompt; and/or (6) presenting, by the one or more processors, the response via the user device, such as via textually, audibly, and/or visually. The method may include additional, less, or alternate functionality, including that discussed elsewhere herein.

For instance, in some embodiments, prior to comparing the vector associated with the first prompt with the vectors associated with the plurality of documents, the method may further include: (1) detecting, by the one or more processors, a stimulus associated with an insurance claim process; and/or (2) retrieving, by the one or more processors, the plurality of documents from a record of a customer database associated with the customer.

In some embodiments, the stimulus may be the customer originating a conversation with an enterprise representative associated with the insurance claim process, the customer updating an insurance claim associated with the insurance claim process, an update to documents associated with the insurance claim process, and/or detecting new documents associated with the insurance claim process.

In some embodiments, comparing the vector associated with the first prompt and the vectors associated with the plurality of documents to identify the one or more candidate documents may include: (1) determining, by the one or more processors, similarity values between the vector associated with the first prompt and the vectors associated with the plurality of documents; and/or (2) selecting, by the one or more processors, the one or more candidate documents based upon the corresponding similarity values.

In some embodiments, the method may further include: (1) receiving, by the one or more processors from the user device, a third prompt associated with the customer; (2) creating, by the one or more processors, a vector associated with the third prompt; (3) determining, by the one or more processors, similarity values between the vector associated with the third prompt and the vectors associated with the plurality of documents; (4) determining, by the one or more processors, that none of the plurality of documents meets a similarity threshold; and/or (5) performing, by the one or more processors, at least one of the following: (a) identifying a second one or more candidate documents from the plurality of documents based upon the corresponding similarity values; and/or (b) presenting a warning to the user via the user device.

In some embodiments, the vectors associated with the plurality of documents may be maintained in a vector database. In some embodiments, ingesting a particular document into the vector database may include: (1) separating, by the one or more processors, the particular document into a set of chunks; (2) creating, by the one or more processors, a respective vector corresponding to the chunks in the set of chunks; and/or (3) storing, by the one or more processors, vectors corresponding to the set of chunks in the vector database.

In some embodiments, comparing the vector associated with the first prompt with the vectors associated with the particular document may include: comparing, by the one or more processors, the vector associated with the first prompt with vectors associated with the respective vectors corresponding to the chunks in the set of chunks.

In some embodiments, the method may further include: maintaining, by the one or more processors, a relationship between the set of chunks and the particular document in a relational data table. Additionally or alternatively, the plurality of documents may include: insurance claim forms, medical records, bills, and/or police reports associated with the customer.

In some embodiments, the first prompt may include an inquiry regarding: an accident history of the customer, a description of an injury of the customer, a causation of an injury of the customer, a health condition of the customer prior to an injury, a general medical history of the customer, a medical history of the customer associated with an injury, a description of a property damage, a causation of a property damage, a repair and/or replacement history associated with a property damage, a description of a property loss, a causation of a property loss, a replacement history associated with a property loss, and/or a monetary amount requested by the customer.

In some embodiments, creating the vector associated with the first prompt may include: (1) splitting, by the one or more processors, the first prompt into semantic clusters; (2) encoding, by the one or more processors, the semantic clusters as a set of vectors, wherein a similarity between the vectors associated with the semantic clusters depends on a relevance between the semantic clusters corresponding to the vectors; and/or (3) calculating, by the one or more processors, a feature vector based upon the set of vectors associated with the semantic clusters, the feature vector being the vector associated with the first prompt.

In some embodiments, encoding the semantic clusters may include: encoding, by the one or more processors and via a machine learning (ML) model comprising a plurality of parameters, the set of vectors, wherein the plurality of parameters are iteratively updated during training of the ML model.

In some embodiments, the chatbot may implement a trained model. In some embodiments, training the model may include: (1) creating a first set of vectors associated with first training data; (2) training the model in a first stage using the first set of vectors; (3) creating a second set of vectors associated with second training data, wherein the second training data include prompts associated with questions and documents, and responses associated with the prompts; and/or (4) training the model in a second stage using the second set of vectors.

In one aspect, a computing system for providing customer-specific information is disclosed herein. The computer system may include one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality glasses or headsets, voice bots or chatbots, ChatGPT or ChatGPT-based bots, and/or other electronic or electrical components, which may be in wired or wireless communication with one another. For example, in some embodiments, the computing system may include: (a) one or more processors, and (b) a non-transitory memory storing one or more instructions. The instructions, when executed by the one or more processors, may cause the one or more processors to: (1) receive, from a user device, a first prompt associated with a customer; (2) create one or more vectors associated with the first prompt; (3) compare the one or more vectors associated with the first prompt with vectors associated with a plurality of documents associated with the customer to identify one or more candidate documents from the plurality of documents; (4) create a second prompt based upon the first prompt and the one or more candidate documents; (5) input the second prompt into a chatbot to obtain a response to the second prompt; and/or (6) present the response to a user via the user device, such as verbally, textually, visually, or graphically. The computer system may include additional, less, or alternate functionality, including that discussed elsewhere herein.

For example, in some embodiments, prior to comparing the vector associated with the first prompt with the vectors associated with the plurality of documents, the instructions, when executed by the one or more processors, may cause the one or more processors to: (1) detect a stimulus associated with an insurance claim process; and/or (2) retrieve the plurality of documents from a record of a customer database associated with the customer.

In some embodiments, to compare the vector associated with the first prompt and the vectors associated with the plurality of documents to identify the one or more candidate documents, the instructions, when executed by the one or more processors, may further cause the one or more processors to: (1) determine a similarity value between the vector associated with the first prompt and the vectors associated with the plurality of documents; and/or (2) select the one or more candidate documents based upon the corresponding similarity values.

In some embodiments, the instructions, when executed by the one or more processors, may further cause the one or more processors to: (1) receive, from the user device, a third prompt associated with the customer; (2) create a vector associated with the third prompt; (3) determine similarity values between the vector associated with the third prompt and the vectors associated with the plurality of documents; (4) determine that none of the plurality of documents meets a similarity threshold; and/or (5) perform at least one of the following: (i) identifying one or more second candidate documents from the plurality of documents based upon the corresponding similarity values; and/or (ii) presenting a warning to the user via the user device.

In some embodiments, the vectors associated with the plurality of documents may be maintained in a vector database, wherein to ingest a particular document into the vector database, the instructions, when executed by the one or more processors, may further cause the one or more processors to: (1) separate the particular document into a set of chunks; (2) create a respective vector corresponding to the chunks in the set of chunks; and/or (3) store vectors corresponding to the set of chunks in a vector database, wherein the vectors associated with the plurality of documents are maintained in the vector database.

In some embodiments, to create the vector associated with the first prompt, the instructions, when executed by the one or more processors, may further cause the one or more processors to: (1) split the first prompt into semantic clusters; (2) encode the semantic clusters as a set of vectors, wherein a similarity between the vectors associated with the semantic clusters depends on a relevance between the semantic clusters corresponding to the vectors; and/or (3) calculate a feature vector based upon the set of vectors associated with the semantic clusters, the feature vector being the vector associated with the first prompt.

In one aspect, a computer readable storage medium storing non-transitory computer readable instructions for providing customer-specific information is disclosed. In some embodiments, the non-transitory computer readable instructions, when executed on one or more processors, may cause the one or more processors to: (1) receive, from a user device, a first prompt associated with a customer; (2) create one or more vectors associated with the first prompt; (3) compare the one or more vectors associated with the first prompt with vectors associated with a plurality of documents associated with the customer to identify one or more candidate documents from the plurality of documents; (4) create a second prompt based upon the first prompt and the one or more candidate documents; (5) input the second prompt into a chatbot to obtain a response to the second prompt; and/or (6) present the response to a user via the user device. The instructions may direct additional, less, or alternate functionality, including that discussed elsewhere herein.

### VI. ADDITIONAL CONSIDERATIONS

Unless otherwise indicated, the processes implemented by an ML chatbot may be implemented by an ML voice bot, an AI chatbot, an AI voice bot, and/or a large language model (LLM).

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing.” “calculating.” “determining.” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled.” however, may also mean that two or more elements are not in direct contact with each other, but yet still co-operate or interact with each other. The embodiments are not limited in this context.

As used herein, the terms “comprises,” “comprising.” “includes,” “including,” “has.” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for providing customer-specific information, comprising:
receiving, by one or more processors from a user device, a first prompt associated with a customer;
creating, by the one or more processors, a vector associated with the first prompt;
comparing, by the one or more processors, the vector associated with the first prompt with vectors associated with a plurality of documents associated with the customer to identify one or more candidate documents from the plurality of documents;
creating, by the one or more processors, a second prompt based upon the first prompt and the one or more candidate documents;
inputting, by the one or more processors, the second prompt into a chatbot to obtain a response to the second prompt; and
presenting, by the one or more processors, the response via the user device.

2. The computer-implemented method of claim 1, wherein prior to comparing the vector associated with the first prompt with the vectors associated with the plurality of documents, the method further comprising:
detecting, by the one or more processors, a stimulus associated with an insurance claim process; and
retrieving, by the one or more processors, the plurality of documents from a record of a customer database associated with the customer.

3. The computer-implemented method of claim 2, wherein the stimulus is the customer originating a conversation with an enterprise representative associated with the insurance claim process, the customer updating an insurance claim associated with the insurance claim process, an update to documents associated with the insurance claim process, and/or detecting new documents associated with the insurance claim process.

4. The computer-implemented method of claim 1, wherein comparing the vector associated with the first prompt and the vectors associated with the plurality of documents to identify the one or more candidate documents comprises:
determining, by the one or more processors, similarity values between the vector associated with the first prompt and the vectors associated with the plurality of documents; and
selecting, by the one or more processors, the one or more candidate documents based upon the corresponding similarity values.

5. The computer-implemented method of claim 1, further comprising:
receiving, by the one or more processors from the user device, a third prompt associated with the customer;
creating, by the one or more processors, a vector associated with the third prompt;
determining, by the one or more processors, similarity values between the vector associated with the third prompt and the vectors associated with the plurality of documents;
determining, by the one or more processors, that none of the plurality of documents meets a similarity threshold;
performing, by the one or more processors, at least one of the following:
(i) identifying a second one or more candidate documents from the plurality of documents based upon the corresponding similarity values; and/or
(ii) presenting a warning to the user via the user device.

6. The computer-implemented method of claim 1, wherein the vectors associated with the plurality of documents are maintained in a vector database, wherein ingesting a particular document into the vector database comprises:
separating, by the one or more processors, the particular document into a set of chunks;
creating, by the one or more processors, a respective vector corresponding to the chunks in the set of chunks; and
storing, by the one or more processors, vectors corresponding to the set of chunks in the vector database.

7. The computer-implemented method of claim 6, wherein comparing the vector associated with the first prompt with the vectors associated with the particular document includes:
comparing, by the one or more processors, the vector associated with the first prompt with vectors associated with the respective vectors corresponding to the chunks in the set of chunks.

8. The computer-implemented method of claim 6, further comprising:
maintaining, by the one or more processors, a relationship between the set of chunks and the particular document in a relational data table.

9. The computer-implemented method of claim 1, wherein the plurality of documents includes: insurance claim forms, medical records, bills, and/or police reports associated with the customer.

10. The computer-implemented method of claim 1, wherein the first prompt includes an inquiry regarding: an accident history of the customer, a description of an injury of the customer, a causation of an injury of the customer, a health condition of the customer prior to an injury, a general medical history of the customer, a medical history of the customer associated with an injury, a description of a property damage, a causation of a property damage, a repair and/or replacement history associated with a property damage, a description of a property loss, a causation of a property loss, a replacement history associated with a property loss, and/or a monetary amount requested by the customer.

11. The computer-implemented method of claim 1, wherein creating the vector associated with the first prompt includes:
splitting, by the one or more processors, the first prompt into semantic clusters;
encoding, by the one or more processors, the semantic clusters as a set of vectors, wherein a similarity between the vectors associated with the semantic clusters depends on a relevance between the semantic clusters corresponding to the vectors; and
calculating, by the one or more processors, a feature vector based upon the set of vectors associated with the semantic clusters, the feature vector being the vector associated with the first prompt.

12. The computer-implemented method of claim 11, wherein encoding the semantic clusters comprises:
encoding, by the one or more processors and via a machine learning (ML) model comprising a plurality of parameters, the set of vectors, wherein the plurality of parameters are iteratively updated during training of the ML model.

13. The computer-implemented method of claim 1, wherein the chatbot implements a trained model, wherein training the model includes:
creating a first set of vectors associated with first training data;
training the model in a first stage using the first set of vectors;
creating a second set of vectors associated with second training data, wherein the second training data include prompts associated with questions and documents, and responses associated with the prompts; and
training the model in a second stage using the second set of vectors.

14. A computing system for providing customer-specific information, comprising:
one or more processors, and
a non-transitory memory storing one or more instructions, the instructions, when executed by the one or more processors, cause the one or more processors to:
receive, from a user device, a first prompt associated with a customer;
create one or more vectors associated with the first prompt;
compare the one or more vectors associated with the first prompt with vectors associated with a plurality of documents associated with the customer to identify one or more candidate documents from the plurality of documents;
create a second prompt based upon the first prompt and the one or more candidate documents;
input the second prompt into a chatbot to obtain a response to the second prompt; and
present the response to a user via the user device.

15. The computing system of claim 14, wherein prior to comparing the vector associated with the first prompt with the vectors associated with the plurality of documents, the instructions, when executed by the one or more processors, cause the one or more processors to:
detect a stimulus associated with an insurance claim process; and
retrieve the plurality of documents from a record of a customer database associated with the customer.

16. The computing system of claim 14, wherein to compare the vector associated with the first prompt and the vectors associated with the plurality of documents to identify the one or more candidate documents, the instructions, when executed by the one or more processors, further cause the one or more processors to:
determine a similarity value between the vector associated with the first prompt and the vectors associated with the plurality of documents; and
select the one or more candidate documents based upon the corresponding similarity values.

17. The computing system of claim 14, wherein the instructions, when executed by the one or more processors, further cause the one or more processors to:
receive, from the user device, a third prompt associated with the customer;
create a vector associated with the third prompt;
determine similarity values between the vector associated with the third prompt and the vectors associated with the plurality of documents;
determine that none of the plurality of documents meets a similarity threshold;
perform at least one of the following:
(i) identifying one or more second candidate documents from the plurality of documents based upon the corresponding similarity values; and/or
(ii) presenting a warning to the user via the user device.

18. The computing system of claim 14, wherein the vectors associated with the plurality of documents are maintained in a vector database, wherein to ingest a particular document into the vector database, the instructions, when executed by the one or more processors, further cause the one or more processors to:
separate the particular document into a set of chunks;
create a respective vector corresponding to the chunks in the set of chunks; and
store vectors corresponding to the set of chunks in a vector database, wherein the vectors associated with the plurality of documents are maintained in the vector database.

19. The computing system of claim 14, wherein to create the vector associated with the first prompt, the instructions, when executed by the one or more processors, further cause the one or more processors to:
split the first prompt into semantic clusters;
encode the semantic clusters as a set of vectors, wherein a similarity between the vectors associated with the semantic clusters depends on a relevance between the semantic clusters corresponding to the vectors; and
calculate a feature vector based upon the set of vectors associated with the semantic clusters, the feature vector being the vector associated with the first prompt.

20. A computer readable storage medium storing non-transitory computer readable instructions for providing customer-specific information, wherein the non-transitory computer readable instructions, when executed on one or more processors, cause the one or more processors to:
receive, from a user device, a first prompt associated with a customer;
create one or more vectors associated with the first prompt;
compare the one or more vectors associated with the first prompt with vectors associated with a plurality of documents associated with the customer to identify one or more candidate documents from the plurality of documents;
create a second prompt based upon the first prompt and the one or more candidate documents;
input the second prompt into a chatbot to obtain a response to the second prompt; and
present the response to a user via the user device.
